(19) United States
(12) Patent Application Publication
(10) Pub. No.: US 2014/0338884 A1
(43) Pub. Date: Nov. 20, 2014

(54) Cooling System having a Cooling Apparatus for Controlling the Temperature of a Battery, and Method for Controlling the Temperature of a Battery

(71) Applicants: Robert Bosch GmbH, Stuttgart (DE); Samsung SDI Co., Ltd., Yongin-si (KR)

(72) Inventors: Marianne Heizmann, Markgroeningen (DE); Oliver Gerundt, Friolzheim (DE)

(73) Assignees: Robert Bosch GmbH, Stuttgart (DE); Samsung SDI Co., Ltd., Yongin-si (KR)

(21) Appl. No.: 14/275,391

(22) Filed: May 12, 2014

(30) Foreign Application Priority Data
May 14, 2013 (DE) 10 2013 208 795.0

(51) Int. Cl. H01M 10/63; H01M 10/613

(52) U.S. Cl. CPC H01M 10/502; H01M 10/5004
USPC 165/287; 165/200

(57) ABSTRACT

A cooling system includes a coolant circuit, and a cooling apparatus positioned in the coolant circuit. Coolant flows through the cooling apparatus so as to control a temperature of a battery positioned in a chamber volume. The cooling system further includes a regulating device configured to regulate a temperature of the cooling apparatus. The cooling system has an element configured to determine a dewpoint temperature prevailing in the chamber volume, and the regulating device is configured to use the element to regulate the temperature of the cooling apparatus such that the temperature of the cooling apparatus is higher than the dewpoint temperature prevailing in the chamber volume.

This application claims priority under 35 U.S.C. §119 to patent application no. DE 10 2013 208 795.0, filed on May 14, 2013 in Germany, the disclosure of which is incorporated herein by reference in its entirety.

The disclosure relates to a cooling system comprising a coolant circuit, comprising a cooling apparatus which is arranged in the coolant circuit and through which coolant flows and which serves for controlling the temperature of a battery arranged in a chamber volume, in particular of a traction battery, and comprising a regulating device for regulating the temperature of the cooling apparatus.

The disclosure also relates to a method for controlling the temperature of a battery which is arranged in a chamber volume and which is in thermal contact with a cooling apparatus, in particular of a traction battery, wherein the temperature of the cooling apparatus is regulated by means of a regulating device in order to control the temperature of the battery.

### BACKGROUND

Batteries, such as in particular traction batteries that are used in hybrid, plug-in hybrid or electric vehicles, and which generally comprise a multiplicity of electrically interconnected rechargeable battery cells, such as in particular lithium-ion cells, can normally be optimally used only in a certain temperature range, for example in a temperature range between 30° C. and 45° C. Operation of a battery outside the optimum temperature range may in this case in particular lead to premature ageing of the battery or even to so-called thermal runaway of battery cells of the battery. Since, during the operation of batteries, in particular of traction batteries, power losses are generated that are converted into heat, the batteries are commonly temperature-controlled using a cooling apparatus. A device for cooling a battery is disclosed for example in the document DE 10 2008 059 969 A1.

Cooling of batteries or of the battery cells thereof in the presence of temperatures higher than the optimum temperature range for the operation of the batteries may in particular lead to local undershooting of the dewpoint temperature, that is to say of the temperature at which the formation of condensate begins to occur. An undershooting of the dewpoint temperature can have the result that moisture that is present in the air surrounding the battery condenses and is precipitated on the cooling apparatus and on the cooled battery. Since the condensed moisture can come into contact with electrically conductive components of the battery or of associated battery components, there is the risk of the condensed moisture causing damage to the battery, in particular because battery components can corrode and/or electrical contacts of the battery can be short-circuited by the condensed moisture.

To counteract the problem of condensed moisture in batteries, document DE 10 2009 054 922 A1 discloses a device for reducing the humidity of the air situated in a battery housing interior compartment designed for accommodating traction batteries. The disclosed device may have a sensor for monitoring humidity and controllable valves for the feed of dry air and/or for the discharge of moist air from the housing.

Furthermore, DE 10 2010 028 861 A1 discloses a battery housing for traction batteries, wherein, in the housing interior compartment, there are arranged a drying agent for absorbing air moisture and a sensor for detecting the humidity of the gas situated in the housing interior compartment. If the drying agent becomes saturated, a sensor signal is generated to indicate that the drying agent should be exchanged.

Against this background, it is an object of the present disclosure to at least reduce the formation of condensate in conjunction with the control of the temperature of a battery using a cooling apparatus, in particular such that means for the removal of condensed moisture, as described in documents DE 10 2009 054 922 A1 and DE 10 2010 028 861 A1, are made superfluous.

### SUMMARY

To achieve the object, there is proposed a cooling system comprising a coolant circuit, comprising a cooling apparatus which is arranged in the coolant circuit and through which coolant flows and which serves for controlling the temperature of a battery arranged in a chamber volume, in particular of a traction battery, and comprising a regulating device for regulating the temperature of the cooling apparatus, wherein the cooling system has means for determining the dewpoint temperature prevailing in the chamber volume, and wherein the regulating device is designed to use the means for determining the dewpoint temperature prevailing in the chamber volume in order to regulate the temperature of the cooling apparatus such that the temperature of the cooling apparatus is higher than the dewpoint temperature prevailing in the chamber volume. The chamber volume in which the battery is arranged may in particular be a chamber volume formed by a battery housing or an installation chamber for a vehicle battery, in particular an installation chamber provided in a vehicle.

As is conventional in the case of a regulating device for regulating the temperature of a cooling apparatus for controlling the temperature of a battery or of a multiplicity of battery cells of a battery, at least one sensor is provided for detecting the temperature of the battery whose temperature is to be controlled or of the battery cells of the battery whose temperature is to be controlled, wherein the cooling power of the cooling apparatus is regulated as a function of the temperature of the battery or as a function of the temperature of the battery cells of the battery. In this regard, in the cooling system according to the disclosure, it is provided that the minimum temperature of the cooling apparatus is regulated so as not to lie below the dewpoint temperature prevailing in the chamber volume in which the battery is arranged. In this way, condensate formation on the cooling apparatus and on the battery whose temperature is to be controlled is advantageously prevented.

Since an increase in cooling power thus cannot be achieved by means of an arbitrary reduction in the temperature of the cooling apparatus, it is provided according to one advantageous embodiment of the disclosure that, to increase the cooling power of the cooling apparatus, the contact surface area between the cooling apparatus and the battery whose temperature is to be controlled is enlarged, in particular by virtue of more than one side of the battery whose temperature is to be controlled being placed in thermal contact with the cooling apparatus.

In particular, it is provided that the temperature of the cooling apparatus is regulated through the supply of a coolant. As coolant, use may be made here in particular of a water-glycol mixture or of a refrigerant, such as R1234yf. The coolant of the cooling system advantageously flows in a meandering fashion through the cooling apparatus. In a further advantageous embodiment, it is provided that the cooling apparatus has a multiplicity of coolant line ducts, through each of which coolant can flow. The temperature control of the cooling apparatus and thus the temperature control of the battery whose temperature is to be controlled by means of the cooling apparatus are advantageously further improved in this way.

One advantageous embodiment of the disclosure provides that the means for determining the dewpoint temperature prevailing in the chamber volume comprise a device which is designed to determine the saturation vapor pressure within the chamber volume in which the battery is arranged, and to determine the dewpoint temperature prevailing in the chamber volume on the basis of the determined saturation vapor pressure.

According to a preferred embodiment of the disclosure, it is provided that the means for determining the dewpoint temperature prevailing in the chamber volume comprise at least one sensor for detecting the chamber volume temperature prevailing in the chamber volume, at least one sensor for detecting the relative air humidity prevailing in the chamber volume, and at least one evaluation device for determining the dewpoint temperature prevailing in the chamber volume by evaluating the detected chamber volume temperature and the detected relative air humidity. The evaluation device may in particular be designed such that, using the chamber volume temperature detected by the at least one temperature sensor, the saturation vapor pressure for the chamber volume is determined, and the dewpoint temperature for the chamber volume is determined at least approximately taking into consideration the detected sensor values regarding the relative air humidity in the chamber volume and the determined saturation vapor pressure. In this embodiment variant, the pressure within the chamber volume is disregarded, in particular by virtue of the pressure within the chamber volume being set as a constant. In particular, the evaluation device of the cooling system according to the disclosure may comprise a microcontroller circuit which may be programmed such that the saturation vapor pressure is initially calculated approximately using the Magnus formula, and the dewpoint temperature for the chamber volume is determined on the basis of the saturation vapor pressure.

The means for determining the dewpoint temperature prevailing in the chamber volume advantageously comprise at least one sensor for detecting the air pressure prevailing in the chamber volume, wherein the evaluation device is designed to determine the dewpoint temperature prevailing in the chamber volume by evaluating the detected chamber volume temperature, the detected relative air humidity and the detected air pressure. In this embodiment variant of the disclosure, for the determination of the dewpoint temperature, it may be provided in particular that the evaluation device determines the dewpoint temperature using a so-called look-up table in which, for different air pressures, predefined temperature values and predefined values of the relative air humidity are assigned a respective dewpoint. Here, use is made of the assignment of temperature, relative humidity and dewpoint temperature as known from the so-called Mollier h-x diagram.

A further advantageous embodiment of the disclosure provides that the cooling system comprises at least one coolant delivery device, wherein the regulating device is designed to regulate the coolant mass flow rate within the cooling system by controlling the at least one coolant delivery device. It is provided in particular that the coolant delivery device is a pump. The delivery rate of the coolant can advantageously be increased or reduced by the regulating device as a function of the cooling power required for controlling the temperature of the battery.

A further advantageous embodiment of the disclosure provides that the cooling system is designed such that coolant, flowing out of the cooling apparatus, of the cooling system can be at least partially conducted through a heat exchanger in order to lower the coolant temperature, and that the cooling system has a throughflow regulating device, wherein the cooling system is designed such that, by means of the throughflow regulating device, coolant flowing to the cooling apparatus is mixed at least partially from coolant flowing out of the cooling apparatus and at least partially from coolant conducted through the heat exchanger. The throughflow regulating device is preferably a valve. The throughflow regulating device can advantageously be controlled by the regulating device of the cooling system. In particular, by means of the throughflow regulating device, it is possible for regulation to be performed such that exclusively coolant flowing out of the cooling apparatus is fed back to the cooling apparatus again, or such that the cooling apparatus is fed exclusively with coolant that has been conducted through the heat exchanger. These are however each special cases of an above-mentioned mixing process. According to a further embodiment of the disclosure, it is provided that the temperature of the heat exchanger is adjustable, preferably using the regulating device of the cooling system.

One advantageous refinement of the disclosure provides that the regulating device of the cooling system is designed to control the throughflow regulating device such that the coolant to be fed to the cooling apparatus is mixed in order to regulate the temperature of the cooling apparatus. If the temperature of the cooling apparatus is to be increased, then the coolant to be supplied to the cooling apparatus is advantageously mixed such that the fraction of coolant flowing out of the cooling apparatus is increased and the fraction of coolant that has been conducted through the heat exchanger is reduced. By contrast, to reduce the temperature of the cooling apparatus, it is advantageously provided that the fraction of coolant flowing out of the cooling apparatus is reduced and the fraction of coolant that has been conducted through the heat exchanger is increased. If the dewpoint temperature in the chamber volume is lower than the temperature of the coolant that has been conducted through the heat exchanger, then the cooling apparatus may in particular also be fed exclusively with the coolant that has been conducted through the heat exchanger.

In one particularly preferred embodiment of the disclosure, it is provided that the regulating device of the cooling system is designed to regulate the coolant mass flow rate within the coolant circuit, taking into consideration the power losses of the battery whose temperature is to be controlled, the relative air humidity in the chamber volume, the coolant temperature, the chamber volume temperature and the air pressure prevailing in the chamber volume, such that the temperature of the cooling apparatus is higher than the dewpoint temperature. It is provided in particular that the heat generated by the battery is detected, as power losses, by measurement of the temperature of the battery or of the battery cells by means of at least one sensor.

To achieve the object mentioned in the introduction, there is also proposed a method for controlling the temperature of a battery which is arranged in a chamber volume and which is in thermal contact with a cooling apparatus, in particular of a traction battery, wherein the temperature of the cooling apparatus is regulated by means of a regulating device in order to control the temperature of the battery, wherein the dewpoint temperature prevailing in the chamber volume is determined, and the temperature of the cooling apparatus is regulated, taking into consideration the determined dewpoint temperature, such that the temperature of the cooling apparatus is higher than the dewpoint temperature. As is known for the regulation of the temperature of a cooling apparatus designed for controlling the temperature of a battery, it is in particular the case that, to regulate the temperature of the cooling apparatus, the temperature of the battery or the temperature of the battery cells of the battery is detected by means of at least one sensor, and the temperature of the cooling apparatus is regulated as a function of the temperature of the battery or of the battery cells. According to the disclosure, the temperature of the cooling apparatus is in this case regulated by the regulating device such that said temperature is higher than the dewpoint temperature of the chamber volume. In this way, condensate formation on the cooling apparatus and condensate formation on the battery whose temperature is to be controlled is advantageously prevented.

In one advantageous embodiment of the method, it is provided that the cooling apparatus is arranged in a coolant circuit of a cooling system, wherein a coolant flows through the cooling apparatus for the purpose of regulating the temperature of the cooling apparatus, and wherein the feed of the coolant to the cooling apparatus is regulated such that the temperature of the cooling apparatus is higher than the dewpoint temperature.

In one advantageous refinement of the method, it is furthermore provided that the coolant that has flowed through the cooling apparatus is discharged and is at least partially conducted through a heat exchanger in order to lower the coolant temperature, wherein coolant that has been conducted through the heat exchanger and coolant that has been discharged directly from the cooling apparatus are mixed such that the coolant temperature of the mixed coolant is higher than the dewpoint temperature.

### BRIEF DESCRIPTION OF THE DRAWINGS

Further advantageous specifics, features and design details of the disclosure will be explained in more detail in conjunction with the exemplary embodiment illustrated in the figure, in which:

The FIGURE shows, in a schematic illustration, an exemplary embodiment of a cooling system according to the disclosure.

### DETAILED DESCRIPTION

An exemplary embodiment of a cooling system according to the disclosure and of a method according to the disclosure for controlling the temperature of a battery which is arranged in a chamber volume and which is in thermal contact with a cooling apparatus will be explained in more detail in conjunction with the FIGURE. Here, the FIGURE shows a cooling system 1 having a cooling apparatus 5 and having a regulating device 12 for regulating the temperature of the cooling apparatus 5. The cooling apparatus 5 serves in this case for controlling the temperature of a battery 4, wherein the battery 4 may in particular be a traction battery constructed from a multiplicity of battery cells. Here, the battery 4 is arranged in a chamber volume 2 formed by a housing 3. The cooling apparatus 5 may in particular be in the form of a cooling plate through which coolant flows and on which—by contrast to the schematic illustration in the FIGURE—the battery 4 is arranged. It may be provided in particular that the sides of the battery 4 are also in thermal contact with the cooling apparatus 5, such that the surface area for the exchange of thermal energy between the cooling apparatus 5 and the battery 4 is enlarged.

The cooling system 1 illustrated in the FIGURE is designed to determine the dewpoint temperature prevailing in the chamber volume 2 and regulate the cooling apparatus 5, as a function of the temperature of the battery 4 whose temperature is to be controlled, such that the temperature of the cooling apparatus 5 is higher than the determined dewpoint temperature. For the detection of the temperature of the cooling apparatus 5 and for the detection of the temperature of the battery 4, respective sensors (not explicitly illustrated in the FIGURE) are provided which transmit temperature measurement values to the regulating device 12. As a means for determining the dewpoint temperature prevailing in the chamber volume 2, the cooling system 1 has a sensor 13 for detecting the chamber volume temperature prevailing in the chamber volume 2. Furthermore, the cooling system 1 has a sensor 14 for detecting the relative air humidity prevailing in the chamber volume 2, and a sensor 15 for detecting the air pressure prevailing in the chamber volume 2. Said sensors 13, 14, 15 are connected to the regulating device 12, for the transmission of the detected measurement values, via sensor lines 16.

The regulating device 12 has an evaluation device (not explicitly illustrated in the FIGURE) as a further means for determining the dewpoint temperature prevailing in the chamber volume 2. It is provided in particular that the evaluation device may have a multiplicity of look-up tables associated with predefined chamber volume internal pressures, in which look-up tables respectively predefined temperature measurement values together with predefined values relating to the relative air humidity are assigned values of a dewpoint temperature. A corresponding assignment of the value pair of temperature measurement value and air humidity measurement value to a dewpoint temperature may be realized as is known in conjunction with a corresponding assignment in the case of so-called Mollier h-x diagrams. Here, detected measurement values are advantageously quantized so as to permit a unique assignment to a dewpoint temperature, wherein the determined dewpoint temperature may be an approximated value of the actual dewpoint temperature. Here, roundings and approximations are performed in conjunction with the determination of the dewpoint temperature such that the determined dewpoint temperature is equal to the actual dewpoint temperature or slightly higher than the actual dewpoint temperature, such that the temperature of the cooling apparatus is not regulated to a value lower than the actual dewpoint temperature, and condensate formation is thus reliably prevented.

In an alternative embodiment of the cooling system 1 illustrated in the FIGURE, it may be provided that the evaluation device is designed to calculate the dewpoint for different air pressures as a function of detected temperature measurement values relating to the chamber volume temperature and detected measurement values relating to the relative air humidity prevailing in the chamber volume 2. For this purpose, the evaluation device advantageously comprises a microcontroller circuit.

Regardless of the manner in which the dewpoint temperature is determined, it is the case in the exemplary embodiment illustrated in the FIGURE that the regulating device 12 regulates the temperature of the cooling apparatus 5, on the basis of the determined dewpoint temperature and the detected temperature of the battery 4 and/or the detected temperature of the cooling apparatus 5, by influencing the coolant 10 that is fed to the cooling apparatus 5. The regulating device 12 may for this purpose control a coolant delivery device 9, which is in the form of a pump, and a throughflow regulating device 8, which is in the form of a valve. By controlling the pump 9, the regulating device 12 can regulate the coolant mass flow rate, that is to say the regulating device 12 can regulate the amount of coolant flowing through the cooling apparatus 5 per unit of time.

Furthermore, the coolant system 1 illustrated in the FIGURE, or the coolant circuit 6, is designed such that the regulating device 12, using the valve 8, can regulate whether and in what fraction coolant 11 that has flowed through the cooling apparatus 5 is fed back to the cooling apparatus 5 as coolant fraction 11′, and to what extent the coolant 11 that has flowed through the coolant apparatus 5 is fed as coolant fraction 11″ to a heat exchanger 7 and subsequently to the cooling apparatus 5 as coolant fraction 11′″. The temperature of the coolant 11″ is lowered by means of the heat exchanger 7. Coolant 10 that is fed to the cooling apparatus 5 will in this case generally have a coolant fraction 11′ and a coolant fraction 11″. In particular, the regulating device 12 of the cooling system 1 may however also control the valve 8 such that the coolant 10 fed to the cooling apparatus 5 is exclusively coolant 11′″ that has been conducted through the heat exchanger 7, or such that exclusively coolant 11′ flowing out of the cooling apparatus 5 is fed back to the cooling apparatus 5 as coolant 10. The regulating device 12 is thus designed such that, by means of the valve 8, coolant 10 that is to be fed to the cooling apparatus 5 is mixed at least partially from coolant 11′ flowing out of the cooling apparatus 5 and at least partially from coolant 11′″ that has been conducted through the heat exchanger 7.

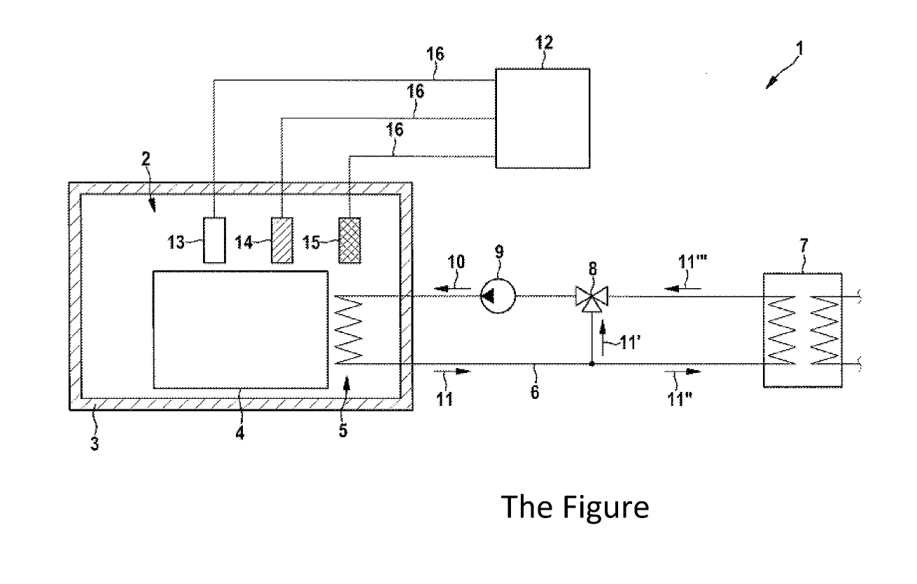

The heat exchanger 7 illustrated in FIG. 1 may operate at a constant temperature. Furthermore, it may in particular be provided that, for further improved regulation of the temperature of the cooling apparatus 5, the temperature of the heat exchanger 7 can be regulated, preferably using the regulating device 12 of the cooling system 1. In the case of such an embodiment, the temperature of the heat exchanger 7 is regulated downward to a maximum extent such that the temperature of the coolant 10 fed to the cooling apparatus 5 is higher than the determined dewpoint temperature.

The cooling system 1 illustrated in the FIGURE is thus advantageously designed to use the regulating device 12 of the cooling system 1 to control the temperature of a battery 4 which is arranged in a chamber volume 2 and which is in thermal contact with a cooling apparatus 5, wherein the temperature of the cooling apparatus 5 for controlling the temperature of the battery 4 is regulated by means of the regulating device 12. Here, the temperature of the battery 4 and the dewpoint temperature prevailing in the chamber volume 2 are determined and the temperature of the cooling apparatus 5 is regulated, taking into consideration the temperature of the battery 4 and the dewpoint temperature, such that the temperature of the cooling apparatus 5 is higher than the dewpoint temperature. Here, a coolant 10 flows through the cooling apparatus 5 for the purpose of regulating the temperature of the cooling apparatus 5, wherein the feed of the coolant 10 to the cooling apparatus 5 is regulated, using the regulating device 12, by controlling the pump 9 and the valve 8 such that the temperature of the cooling apparatus 5 is higher than the dewpoint temperature. It is provided here in particular that coolant 11 that has flowed through the cooling apparatus 5 is at least partially conducted through a heat exchanger 7 in order to lower the coolant temperature, wherein coolant 11′″ that has been conducted through the heat exchanger 7 and coolant 11′ that has been discharged directly from the cooling apparatus are mixed such that the coolant temperature of the mixed coolant 10 is higher than the dewpoint temperature.

The exemplary embodiment illustrated in the FIGURE and explained in conjunction with the FIGURE serves for the explanation of the disclosure, and does not restrict the disclosure.

What is claimed is:

1. A cooling system, comprising:
a coolant circuit;
a cooling apparatus positioned in the coolant circuit, the cooling apparatus positioned and configured so that coolant to flows therethrough so as to control a temperature of a battery that is positioned in a chamber volume;
an element configured to determine a dewpoint temperature prevailing in the chamber volume; and
a regulating device configured to regulate a temperature of the cooling apparatus by using the element, such that the temperature of the cooling apparatus is higher than the dewpoint temperature.

2. The cooling system according to claim 1, wherein the element includes:
at least one sensor configured to detect a temperature prevailing in the chamber volume:
at least one sensor configured to detect a relative air humidity prevailing in the chamber volume; and
at least one evaluation device configured to determine the dewpoint temperature by evaluating the detected temperature prevailing in the chamber volume and the detected relative air humidity prevailing in the chamber volume.

3. The cooling system according to claim 2, wherein:
the element includes at least one sensor configured to detect an air pressure prevailing in the chamber volume; and
the evaluation device is configured to determine the dewpoint temperature by evaluating the detected temperature prevailing in the chamber volume, the detected relative air humidity prevailing in the chamber volume, and the detected air pressure prevailing in the chamber volume.

4. The cooling system according to claim 1, further comprising at least one coolant delivery device, wherein the regulating device is configured to regulate a coolant mass flow rate within the cooling system by controlling the at least one coolant delivery device.

5. The cooling system according to claim 1, wherein:
coolant flowing out of the cooling apparatus is at least partially conducted through a heat exchanger in order to lower a temperature of the coolant; and
the cooling system further comprises a throughflow regulating device, via which coolant flowing into the cooling apparatus is mixed at least partially from coolant flowing out of the cooling apparatus and at least partially from coolant conducted through the heat exchanger.

6. The cooling system according to claim 5, wherein the regulating device is configured to control the throughflow regulating device such that the coolant flowing into the cooling apparatus is mixed in such a way as to regulate the temperature of the cooling apparatus.

7. The cooling system according to claim 1, wherein the regulating device is configured to regulate a coolant mass flow rate within the coolant circuit based at least in part upon power losses of the battery, a relative air humidity in the chamber volume, a coolant temperature, a temperature of the chamber volume, and an air pressure prevailing in the chamber volume, such that the temperature of the cooling apparatus is higher than the dewpoint temperature.

8. A method of controlling a temperature of a battery that is positioned in a chamber volume and that is in thermal contact with a cooling apparatus regulated by a regulating device for controlling the temperature of the battery, comprising:
determining a dewpoint temperature prevailing in the chamber volume; and
regulating the temperature of the cooling apparatus based at least in part upon the dewpoint temperature, such that the temperature of the cooling apparatus is higher than the dewpoint temperature.

9. The method according to claim 8, wherein the cooling apparatus is positioned in a coolant circuit of a cooling system, the method further comprising:
flowing coolant through the cooling apparatus in order to regulate the temperature of the cooling apparatus; and
regulating a feed of the coolant flowing to the cooling apparatus such that the temperature of the cooling apparatus is higher than the dewpoint temperature.

10. The method according to claim 9, further comprising:
discharging coolant that has flowed through the cooling apparatus;
at least partially conducting the coolant that has flowed through the cooling apparatus through a heat exchanger so as to lower a temperature of coolant flowing through the heat exchanger; and
mixing coolant directly discharged from the cooling apparatus with the coolant flowing through the heat exchanger, such that a temperature of a mixed coolant is higher than the dewpoint temperature.
